(19) United States
(12) Patent Application Publication
(10) Pub. No.: US 2014/0164935 A1
(43) Pub. Date: Jun. 12, 2014

(54) SYSTEM FOR RAPID BROWSING OF CONTENT

(71) Applicants: Dror FROMMER, Livingston, NJ (US); Ronen MIKAY, Old Tappan, NJ (US); Bess LIPSCHUTZ, Brooklyn, NY (US)

(72) Inventors: Dror FROMMER, Livingston, NJ (US); Ronen MIKAY, Old Tappan, NJ (US); Bess LIPSCHUTZ, Brooklyn, NY (US)

(21) Appl. No.: 13/712,443

(22) Filed: Dec. 12, 2012

(51) Int. Cl. G06F 3/0481

(52) U.S. Cl. CPC G06F 3/0481; H04L 67/06
USPC 715/738

(57) ABSTRACT

A graphical user interface adapted to extend the functionality of, for instance, a web browser operating on a personal computing device in communication via a network connection to a remote computing resource, where the graphical user interface includes a glyph overlaying and visible over the browser and any content displayed by the browser wherein activation of the glyph by a user of the browser causes the browser to seek to open an overlaying window according to parameters and content specified by the remote computing resource at a network address associated with the glyph.

### FIELD OF INVENTION

The invention relates generally to the field of computer user interfaces and particularly to facilitating rapid access to favored content or operations.

### BACKGROUND OF THE INVENTION

A variety of tools are available for distribution of electronic media and loyalty rewards to consumers on the world-wide-web.

For example, U.S. Patent Application U.S. 2008/0097871 A1 (Williams, et al.) titled “Method and system for providing a widget usable in affiliate marketing” describes a system and computer implemented method for providing a widget are described. The method and system include rendering the widget on a site. The widget dynamically displays multimedia content associated with a campaign. The widget is also embeddable, copyable, and allows for at least one user action. The method and system also include receiving at least one input related to the at least one action and updating the widget based on a goal corresponding to the at least one action.

Similarly, U.S. 2008/0195483 A1 (Moore) titled “Widget management systems and advertising systems related thereto” describes systems and methods supporting use, re-use, and recomposition of widgets and other web content, such as by providing a user interface for controlling the interrelationship and display of widgets and the like. In one aspect, an OPML-based system expresses relationships among discrete components of web content through an OPML outline. In another aspect, a URL-based service dynamically creates composite web content according to functional calls posted to a web-accessible URL.

However, there remains a need for a friendly consumer participation tool that plugs into a consumer's browser to deliver, for instance, a live customized stream of relevant opt-in content. Specifically, interfaces could be better tailored to allow consumers to identify, register, and link into brands, content, institutions, or organizations with which they feel strong affinities.

### SUMMARY

A graphical user interface is adapted to extend the functionality of, for instance, a web browser operating on a personal computing device in communication via a network connection to a remote computing resource. The graphical user interface includes a glyph overlaying and visible over the browser and any content displayed by the browser. Activation of the glyph by a user of the browser causes the browser to seek to open an overlaying window according to parameters and content specified by the remote computing resource at a network address associated with the glyph.

Once the overlaying window opens according to parameters and content specified at the network address associated with the glyph, the user may for instance browse, view, or download content provided from a feed affiliated with the network address associated with the glyph. The feed could be a web site, RSS, XML, API, Twitter, Facebook, or other web feed or similar data channel. Through the overlaying window the user may also, for instance, upload data, post an entry, respond to a query, donate content, or answer a survey.

The glyph may be an emblem of a consumer or industrial product, a consumer or industrial product producer, a sports team, an online service, or a governmental institution, non-profit institution, or educational institution. The personal computing device may be a desktop computer, a laptop computer, a tablet computer, a personal digital assistant, a cellular telephone, a television, or a game console.

The graphical user interface is arranged to register a personal account for the user at the network address associated with the glyph using geolocation devices or network device data. The appearance of the glyph can vary with the status of the personal account, operational state, or selection by the user. The glyph may appear at different times as: a picture or evocative symbol; a small indicator; or a window, microsite, or portal.

Glyphs may be moved singly or in combination by the user. The location of glyphs may be free-floating or anchored to some portion of the boundary of the display.

### DESCRIPTION OF THE DRAWINGS

FIG. 1 is a schematic representation of a hardware platform on which the invention may be implemented.

FIG. 2 is a schematic representation of a screen being viewed by a user of an embodiment of the invention.

FIG. 3 is a schematic representation of a screen being viewed by the user of the embodiment of the invention depicted in FIG. 2, but during a different state of operation.

FIG. 4 is a schematic representation of a screen being viewed by a user of an alternative embodiment of the invention.

### DETAILED DESCRIPTION

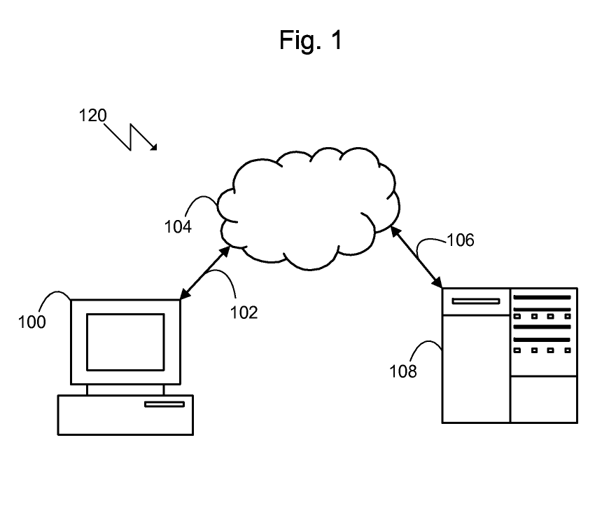

FIG. 1 is a schematic representation of a hardware platform on which the invention may be implemented. The system 120 includes a personal computing device (PC) 100, which may be a desktop computer, a laptop computer, a tablet computer, a personal digital assistant, a cellular telephone, a television, a game console, or any equivalent thereof. PC 100 is connected to a network 104 via a link 102. Network 104 could include any telecommunications network or digital computing local or wide area network. It could include the world-wide web or the Internet. Network 104 provides a connection to PC 100 via link 106 to a remote computing resource 108, such as an application or data server or web site. Links 102 could include any conventional technologies such as wired, wireless, and optical data transmission and connection equipment.

The software necessary to implement the invention is preferably obtained by a user on his PC 100 from the remote resource 108. He installs it on his PC 100, perhaps specifying a particular software application, such as a browser, into which the inventive features are to be integrated. Various development platforms are available such as ASP.NET AJAX, JavaScript, and C++ for implementing extensions to browsers and the like.

Preferably, upon installation the inventive feature software registers its installation by providing the remote computing resource 108 with identifying information including geolocation data about the PC 100 for the purpose of registering a new user account with the remote computing resource 108. The physical coordinates of PC 100 could be provided, for example, via Internet protocol network data, whereby parameters or identifiers of the various network equipment routing communications are used to determine the probable or approximate physical location of PC 100. Alternatively, if PC 100 is provided with a global positioning system (GPS) device, latitude and longitude data could be provided. Other information that could be provided includes, for example: the serial number of PC 100, or of its processor; the network address of PC 100; or software or data residing on PC 100. These are but a few examples of many other possible ways to uniquely identify the user account. Alternatively, the user could be prompted to provide, for instance, an account identifier and password.

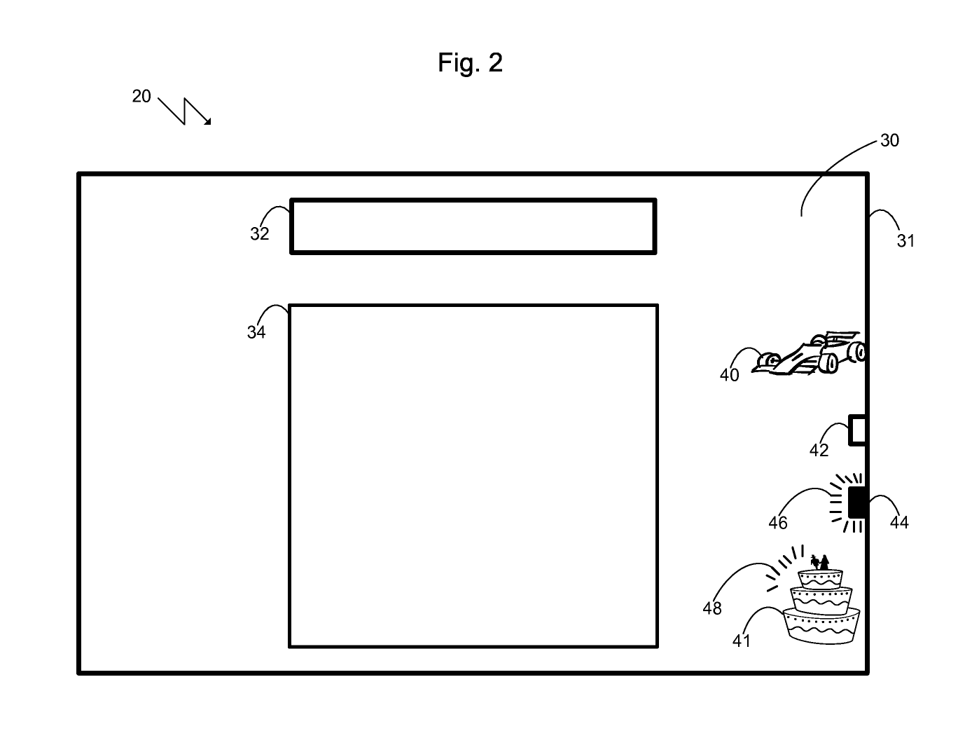

FIG. 2 is a schematic depiction of a user's view of an illustrative embodiment of the invention. The display screen of a graphical user interface operating on a personal computing device is shown. Not shown but assumed for purposes of this example a desktop personal computer equipped with a mouse, keyboard, and display screen serving as PC 100 of FIG. 1, along with the rest of the hardware depicted in FIG. 1.

For brevity, the graphical user interface is described as an enhanced Internet web browser operation. It will be readily appreciated that the inventive concepts could easily be adapted to a wide variety of computing platforms and such applications as word processing or gaming, where rapid intermittent access to (potentially unrelated) remote data is desired by the user.

In FIG. 2, a graphical user interface (GUI) 20 has a display 30 with a boundary 31. Boundary 31 is either the physical limit of a user interface screen or a graphical boundary of a displayed window. Here GUI 20 is shown displaying the contents of an Internet web site which includes a title banner 32 and content 34.

Four glyphs 40, 41, 42, and 44 are shown. Herein “glyph” refers to both a visual element of the GUI 20 (that can take a number of forms) and also the software and data associated with the visual element. In FIG. 2 glyph 40 is depicted as an evocative symbol of a race car. The visual form of glyph 40 is suggestive of the content that the user may be able to access by activating the glyph, e.g., by clicking on it. Glyph 41 is depicted as an evocative symbol of a wedding cake.

Examples of useful evocative symbol glyphs are emblems of: consumer or industrial products; consumer or industrial product producers; sports teams; online search, news, entertainment, media, or social networking service or provider; or governmental, non-profit, or educational institutions.

Glyph 40 overlays display 30, as do the other glyphs. “Overlays” means that glyph 40 remains visible over the other content even if the user navigates to a different web site with a different title banner and different content. Glyph 40 would still appear layered atop the new web site just where Glyph 40 was while the user viewed the first web site. Thus glyph 40 overlays all other content, rather than being, for example, an element of a particular web site being displayed by GUI 20.

Glyph 40 is preferably anchored to boundary 31. “Anchored” means that glyph 40 remains in a similar position relative to boundary 31 even if boundary 31 is moved or altered in size.

A glyph can be “hidden” by the user, e.g., by clicking on a particular portion of it. Preferably, “hidden” means being reduced to a very small and unobtrusive visual indicator, rather than being invisible to the user. Glyphs 42 and 44 are depicted as “hidden” in this way. In hidden form, these glyphs are not suggestive of any particular content. They are simply small reminders to the user of where to click to see certain information. However it is useful to the user that Glyphs 42 and 44 remain visually distinct. In FIG. 2 they are differentiated from each other by their color.

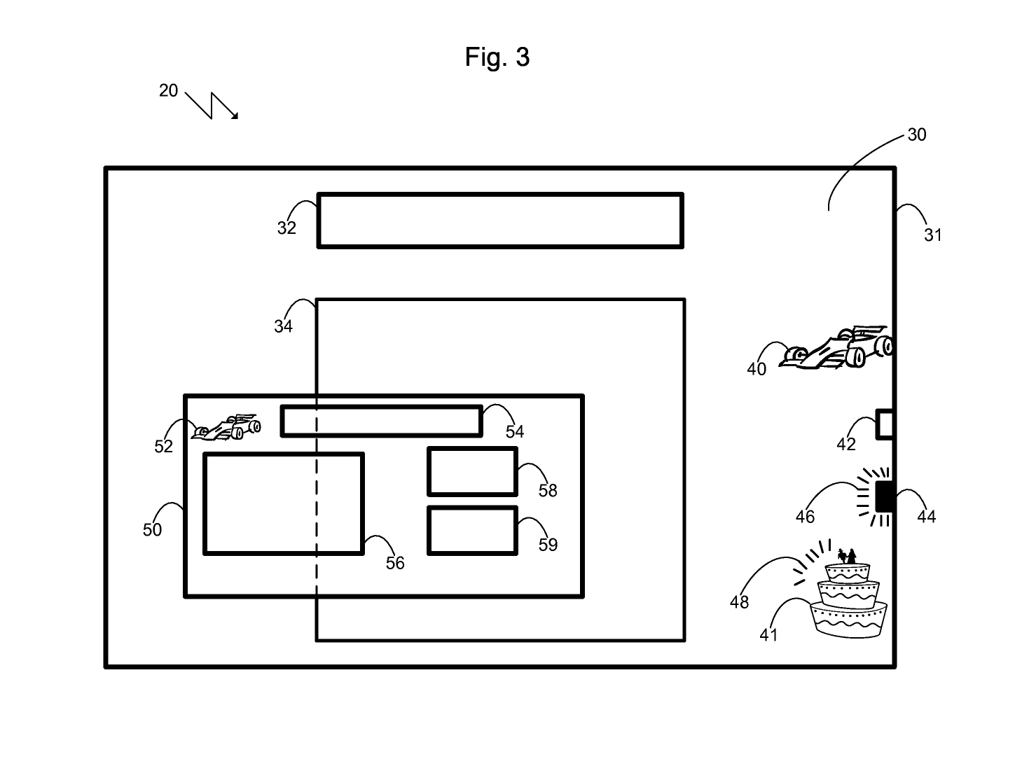

FIG. 3 again depicts GUI 20, but in a different state. Here the user has clicked on glyph 40, triggering GUI 20 to seek to display content at a network address associated with the glyph 40. Finding the content GUI 20 has opened overlaying window 50.

Information found at the network address associated with the glyph 40 controls the parameters of how GUI 20 opens an overlaying window 50 to provide content to the user from a web site at that address. Successfully retrieved data might include: another banner 54; content 56; advertisement 58; links 59; and another evocative symbol 52, which may or may not be similar to the evocative symbol used for glyph 40.

A second left click could minimize or hide window 50. This would allow the user to quickly switch between viewing primary content 34 and glyph-affiliated overlaying window 50.

The vertical dotted line on FIG. 3 indicates that when window 50 is open it is layered over window 30, and therefore occludes some content of window 30, e.g., content 34.

The user may perform any normal browser operation in window 50. For example, the user may browse, view, or download content provided from a feed affiliated with the network address associated with the glyph 40. . The feed could be a web site, RSS, XML, API, Twitter, Facebook, or other web feed or similar data channel. Through overlaying window 50 the user may also, for instance, upload data, post an entry, respond to a query, donate content, or answer a survey.

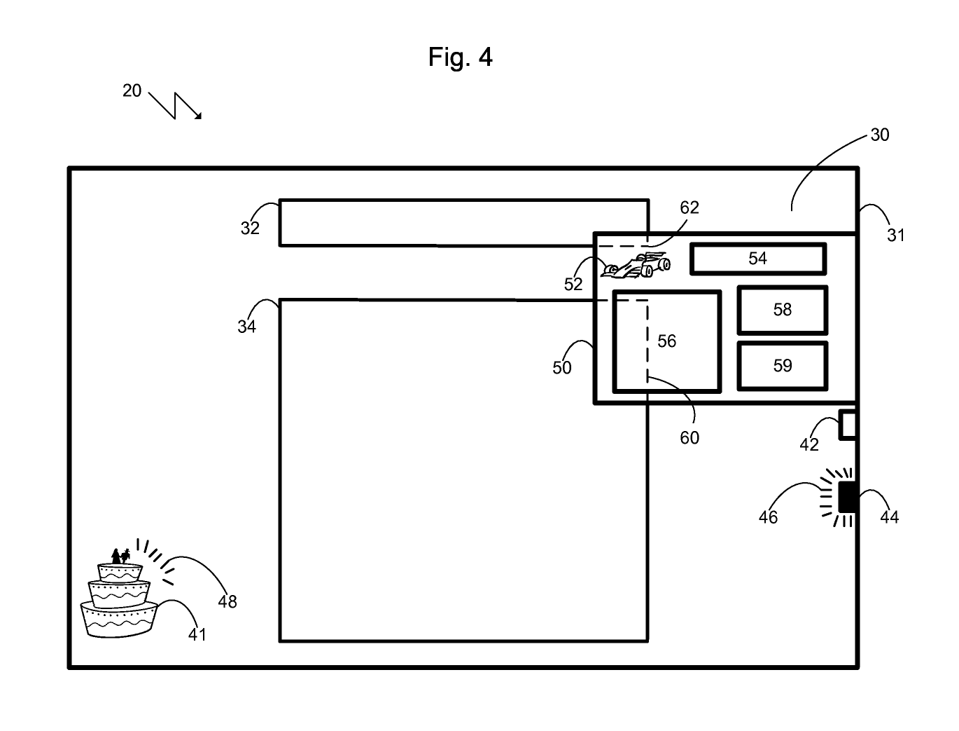

In FIG. 3, Glyph 40 is depicted as being visible on display 30. Alternatively, as will be discussed below in reference to FIG. 4, overlaying window 50 could be another visual form of glyph 40, such that when overlaying window 50 is open, no other representation of glyph 40 (i.e., no evocative symbol) is visible on display 30. The appearance of a glyph can be altered to signify a change in the status of information available from the remote resource at the network address associated with the glyph. A glyph may change color, blink, or be highlighted with a halo, for instance, to signify that new, requested, or special content is now available from the remote resource. This is true whether the visual form of the glyph is that of an evocative symbol, overlaying window, or “hidden” glyph indicator. For example, in FIG. 3, minimized glyph 44 is depicted as having an associated halo 46. Glyph 41 is also shown as having a conditional highlight 48.

The user may choose to leave glyphs unanchored or change where glyphs are anchored. To change where they are anchored, the user first selects one or more glyphs, and then drags the glyph or group of glyphs to the desired position on the GUI 20 display. Typically, glyphs are anchored at the right or left of boundary 31, but they may also be anchored to the top or bottom. Glyphs may also be placed elsewhere without being anchored to any boundary.

FIG. 4 shows a slightly altered embodiment of GUI 20 seen in FIGS. 2 and 3. Here, overlaying window 50 is anchored to the right side of boundary 31. In this case, overlaying window 50 is the maximized form of glyph 40, and so evocative symbol form of glyph 40 is not visible separately.

In this alternative embodiment, the evocative symbol of glyph 40 could be said to be the “minimized” representation of overlaying window 50, and a symbol like that of glyph 42 or 44 be said to be the “hidden” representation of overlaying window 50. Overlaying window 50 would then be the “maximized” form of glyph 40.

Note also here that overlaying window 50 is depicted as smaller than in FIG. 3. Such overlaying windows preferably should not interfere overly with, for example, banner 32 and content 34 displayed beneath it. Rather, overlaying window 50 acts as a “microsite”—a small portal which the user may enjoy concurrently while exploring other content on display 30. However, overlaying window 50 may impact the user's experience of other content on display 30. In this example, as indicated by dashed lines 60 and 62, some portion of the material beneath overlaying window 50 may be occluded by it.

We claim:

1. A graphical user interface adapted to extend the functionality of a web browser operating on a personal computing device in communication via a network connection to a remote computing resource, the graphical user interface comprising:
a. a display;
b. a glyph overlaying and thus visible over the browser and any content displayed by the browser on the display; and
c. a network address associated with the glyph,
wherein activation of the glyph by a user of the browser causes the browser to seek to open an overlaying window according to parameters and content specified by the remote computing resource at the network address associated with the glyph.

2. The graphical user interface of claim 1 wherein the glyph is an emblem of: a consumer or industrial product; a consumer or industrial product producer; a sports team; an online search, news, entertainment, media, or social networking service or provider; a governmental institution, non-profit institution, or educational institution.

3. The graphical user interface of claim 2 wherein the personal computing device is a desktop computer, a laptop computer, a tablet computer, a personal digital assistant, or a cellular telephone, a television, or a game console.

4. The graphical user interface of claim 3 wherein the glyph appears alternately as an evocative symbol or a small indicator.

5. The graphical user interface of claim 3 wherein the glyph appears alternately as an evocative symbol or the overlaying window.

6. The graphical user interface of claim 3 wherein the graphical user interface is arranged to register a personal account at the network address associated with the glyph using Internet protocol network device location data or a global positioning system device.

7. The graphical user interface of claim 6 wherein the appearance of the glyph varies in accordance with a condition where the condition is either (a) new content being available at the network address associated with the glyph or (b) a change in a status of the personal account

8. The graphical user interface of claim 3 where, upon successful opening of the window according to parameters and content specified at the network address associated with the glyph, the user may browse, view, or download content provided from a feed affiliated with the network address associated with the glyph.

9. The graphical user interface of claim 8 where the feed is a web site, RSS, XML, API, Twitter, or Facebook data channel.

10. The graphical user interface of claim 3 where, upon successful opening of the window according to parameters and content specified at the network address associated with the glyph, the user may upload data, post an entry, respond to a query, donate content, or answer a survey.

11. The graphical user interface of claim 3 wherein the user may select a portion of a boundary of the display of the graphical user interface to which the glyph is to be anchored by selecting and dragging the glyph the portion of the boundary.

12. The graphical user interface of claim 10 wherein the user may select a portion of a boundary of the display of the graphical user interface to which a collection of glyphs is to be anchored by selecting and dragging the collection of glyphs to that portion of the boundary.
